(19) United States
(12) Patent Application Publication
(10) Pub. No.: US 2025/0297711 A1
(43) Pub. Date: Sep. 25, 2025

(54) HYDROGEN STORAGE DEVICE

(71) Applicant: TOYOTA JIDOSHA KABUSHIKI KAISHA, Toyota-shi (JP)

(72) Inventors: Yuya SUGITA, Toyota-shi (JP); Toshiyuki SANADA, Toyota-shi (JP); Nobukazu MIZUNO, Nagakute-shi (JP)

(73) Assignee: TOYOTA JIDOSHA KABUSHIKI KAISHA, Toyota-shi (JP)

(21) Appl. No.: 18/979,935

(22) Filed: Dec. 13, 2024

(30) Foreign Application Priority Data
Mar. 19, 2024 (JP) 2024-043294

(51) Int. Cl. F17C 13/04

(52) U.S. Cl. CPC F17C 13/045; F17C 2201/0104; F17C 2205/0142; F17C 2205/0326; F17C 2205/0352; F17C 2221/012; F17C 2223/0123; F17C 2223/036; F17C 2225/0123; F17C 2225/036; F17C 2227/043; F17C 2250/03; F17C 2250/0417; F17C 2250/043

(57) ABSTRACT

The hydrogen storage device may include a plurality of hydrogen tanks and a plurality of supply pipes corresponding to each of the plurality of hydrogen tanks, each of the plurality of supply pipes connecting the hydrogen tank and a supply destination to which hydrogen in the hydrogen tank is supplied, a plurality of solenoid valves provided in each of the plurality of supply pipes, and a control device capable of executing a hydrogen supply operation of supplying hydrogen to the supply destination by controlling the operation of the plurality of solenoid valves. In the hydrogen supply operation, the control device sets only the first solenoid valve out of the plurality of solenoid valves to the open state, sets the solenoid valve other than the first solenoid valve to the closed state, and changes the solenoid valve set as the first solenoid valve when the predetermined condition is satisfied.

### CROSS-REFERENCE TO RELATED APPLICATION

This application claims priority to Japanese Patent Application No. 2024-043294 filed on Mar. 19, 2024, incorporated herein by reference in its entirety.

### BACKGROUND

### 1. Technical Field

The technique disclosed herein relates to hydrogen storage devices.

### 2. Description of Related Art

Japanese Unexamined Patent Application Publication No. 2015-132350 (JP 2015-132350 A) describes a hydrogen storage device. The hydrogen storage device includes a plurality of hydrogen tanks, a plurality of supply pipes, a plurality of solenoid valves, and a control device. The supply pipes correspond to the hydrogen tanks. The hydrogen tanks and a supply destination to which hydrogen in the hydrogen tanks is to be supplied are connected by the supply pipes. The solenoid valves are installed in the supply pipes. The control device is configured to perform a hydrogen supply operation in which the control device controls operation of the solenoid valves to supply hydrogen to the supply destination.

### SUMMARY

In the hydrogen storage device of JP 2015-132350 A, the solenoid valves are simultaneously opened in the hydrogen supply operation. That is, hydrogen gas is simultaneously supplied from the hydrogen tanks to the supply destination. With this configuration, the tank pressures of the hydrogen tanks decrease in the same manner. When the tank pressures of the hydrogen tanks decrease to the same level as the pressure of the supply destination, the hydrogen gas can no longer be supplied to the supply destination. At this time, hydrogen remains in each of the hydrogen tanks in the same manner, so that a relatively large amount of hydrogen gas remains overall in the hydrogen tanks.

The present specification provides a technique that allows to effectively use hydrogen gas stored in a plurality of hydrogen tanks.

According to a first aspect disclosed in the present specification,
a hydrogen storage device includes:
a plurality of hydrogen tanks;
a plurality of supply pipes corresponding to the hydrogen tanks and each connecting a corresponding one of the hydrogen tanks and a supply destination to which hydrogen gas in the hydrogen tank is to be supplied;
a plurality of solenoid valves installed in the supply pipes; and
a control device configured to perform a hydrogen supply operation in which the control device controls operation of the solenoid valves to supply hydrogen gas to the supply destination.
   The control device is configured to, in the hydrogen supply operation,
set part of the solenoid valves as a target solenoid valve to open the target solenoid valve and close the solenoid valves other than the target solenoid valve, and
when a predetermined condition is satisfied, change the solenoid valve set as the target solenoid valve.

With the above configuration, only the target solenoid valve is opened in the hydrogen supply operation. In this case, each hydrogen tank may have a different tank pressure. Therefore, when the tank pressure of any one of the hydrogen tanks is higher than the pressure of the supply destination, the hydrogen gas can be supplied to the supply destination in the hydrogen supply operation. The hydrogen gas stored in the hydrogen tanks can thus be effectively used.

According to a second aspect, in the first aspect,
the predetermined condition may be satisfied when an amount of change in a tank pressure of the hydrogen tank corresponding to the target solenoid valve becomes equal to or less than a predetermined value.

With the above configuration, the solenoid valve set as the target solenoid valve can be changed at the timing when supply of the hydrogen gas from the hydrogen tank corresponding to the target solenoid valve to the supply destination decreases.

According to a third aspect, in the first or second aspect,
the control device may be configured to set the solenoid valve as the target solenoid valve in an ascending order from the solenoid valve corresponding to the hydrogen tank that has a lowest tank pressure at start of the hydrogen supply operation.

In the hydrogen supply operation, the pressure of the supply destination increases as the hydrogen gas is supplied to the supply destination. Therefore, the pressure of the supply destination may become higher than the lowest tank pressure during the hydrogen supply operation. With the above configuration, opening the solenoid valve corresponding to the hydrogen tank having the lowest tank pressure can increase the possibility of the hydrogen gas being supplied from that hydrogen tank to the supply destination. The hydrogen gas stored in the hydrogen tanks can thus be effectively used.

According to a fourth aspect disclosed in the present specification, a hydrogen storage device includes:
a plurality of hydrogen tanks;
a plurality of supply pipes corresponding to the hydrogen tanks;
a plurality of solenoid valves installed in the supply pipes; and
a control device configured to perform a hydrogen supply operation in which the control device controls operation of the solenoid valves to supply hydrogen gas to a supply destination.
The control device is configured to, in the hydrogen supply operation,
open a first target solenoid valve out of the solenoid valves and close the solenoid valves other than the first target solenoid valve,
when, with the first target solenoid valve opened and the solenoid valves other than the first target solenoid valve closed, a hydrogen gas supply amount from a first hydrogen tank corresponding to the first target solenoid valve becomes equal to or less than a first predetermined amount, open a second target solenoid valve out of the solenoid valves, and
when, after the second target solenoid valve is opened, the hydrogen gas supply amount from the first hydrogen tank becomes equal to or less than a second predetermined amount smaller than the first predetermined amount, close the first target solenoid valve.

With the above configuration, either the first target solenoid valve or both the first target solenoid valve and the second target solenoid valve are opened in the hydrogen supply operation. In this case, each hydrogen tank may have a different tank pressure. Therefore, when the tank pressure of any one of the hydrogen tanks is higher than the pressure of the supply destination, the hydrogen gas can be supplied to the supply destination in the hydrogen supply operation. The hydrogen gas stored in the hydrogen tanks can thus be effectively used.

According to a fifth aspect, in the fourth aspect,
at start of the hydrogen supply operation, a tank pressure of the hydrogen tank corresponding to the second target solenoid valve may be higher than a tank pressure of the hydrogen tank corresponding to the first target solenoid valve.

The above configuration can increase the possibility that the hydrogen gas may be supplied from the hydrogen tank corresponding to the second target solenoid valve to the supply destination after the state changes. After the state changes means after the state changes from the state in which only the first target solenoid valve is open to the state in which the first target solenoid valve and the second target solenoid valve are open.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a configuration of a supply system 2;

FIG. 2 is a flowchart of a hydrogen supply operation process according to the first embodiment;

FIG. 3 is a view showing a situation in which hydrogen gas is supplied to a supply destination tank in the first embodiment;

FIG. 4 is a diagram showing a situation in which hydrogen gas is supplied to a supply destination tank in a comparative example;

FIG. 5 is a flow chart diagram of a hydrogen supply operation process according to a second embodiment; and

FIG. 6 is a time chart according to the second embodiment.

### DETAILED DESCRIPTION OF EMBODIMENTS

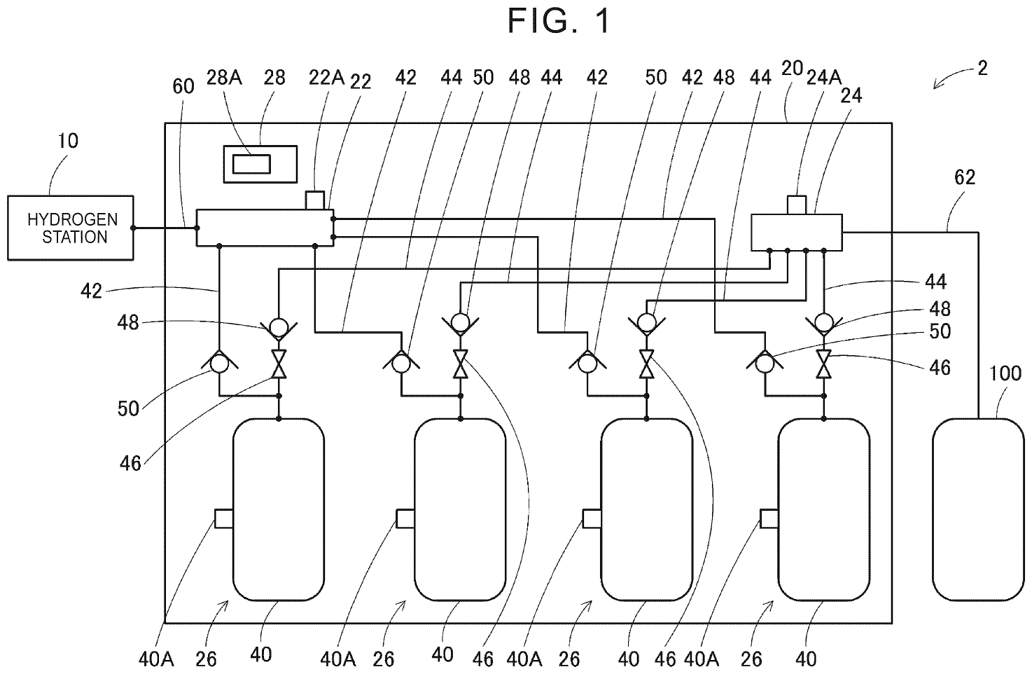

As illustrated in FIG. 1, the supply system 2 includes a hydrogen station 10, a hydrogen storage device 20, and a supply destination tank 100. The hydrogen station 10 supplies hydrogen gas to the mobile hydrogen storage device 20. In one embodiment, the supply destination tank 100 is mounted on a fuel cell electric vehicle.

The hydrogen storage device 20 includes a filling pipe connecting portion 22, a supply pipe connecting portion 24, a plurality of hydrogen tank units 26, and a control device 28. The plurality of hydrogen tank units 26 are arranged in parallel to the filling pipe connecting portion 22 and the supply pipe connecting portion 24.

The hydrogen tank unit 26 includes a hydrogen tank 40, a first filling pipe 42, and a first supply pipe 44. Hydrogen gas is stored in the hydrogen tank 40. The hydrogen tank 40 is provided with a temperature sensor 40A for detecting the tank temperature in the hydrogen tank 40. The first supply pipe 44 connects the hydrogen tank 40 and the supply pipe connecting portion 24. The first supply pipe 44 is provided with a solenoid valve 46 and a supply-side check valve 48. The solenoid valve 46 is provided between the hydrogen tank 40 and the supply-side check valve 48. The solenoid valve 46 opens and closes the first supply pipe 44. The supply-side check valve 48 reduces or eliminates the possibility of hydrogen flowing from the supply pipe connecting portion 24 toward the hydrogen tank 40. The first filling pipe 42 connects the first supply pipe 44 and the filling pipe connecting portion 22. The first filling pipe 42 is connected to the first supply pipe 44 between the 20 hydrogen tank 40 and the solenoid valve 46. The first filling pipe 42 is provided with a filling-side check valve 50. The filling-side check valve 50 reduces or eliminates the possibility of hydrogen gas flowing from the hydrogen tank 40 toward the filling pipe connecting portion 22.

The filling pipe connecting portion 22 is connected to four first filling pipes 25 42 and a second filling pipe 60 connecting the hydrogen station 10 and the hydrogen storage device 20. The filling pipe connecting portion 22 is provided with a first pressure sensor 22A.

Four first supply pipes 44 and a second supply pipe 62 connecting the hydrogen storage device 20 and the supply destination tank 100 are connected to the supply 30 pipe connecting portion 24. A second pressure sensor 24A is provided in the supply pipe connecting portion 24.

The control device 28 is a computer including a CPU. The control device 28 controls the operation of each component of the hydrogen storage device 20 to execute the hydrogen supply operation. The control device 28 includes a memory 28A. The memory 28A stores the tank pressure of the respective hydrogen tanks 40.

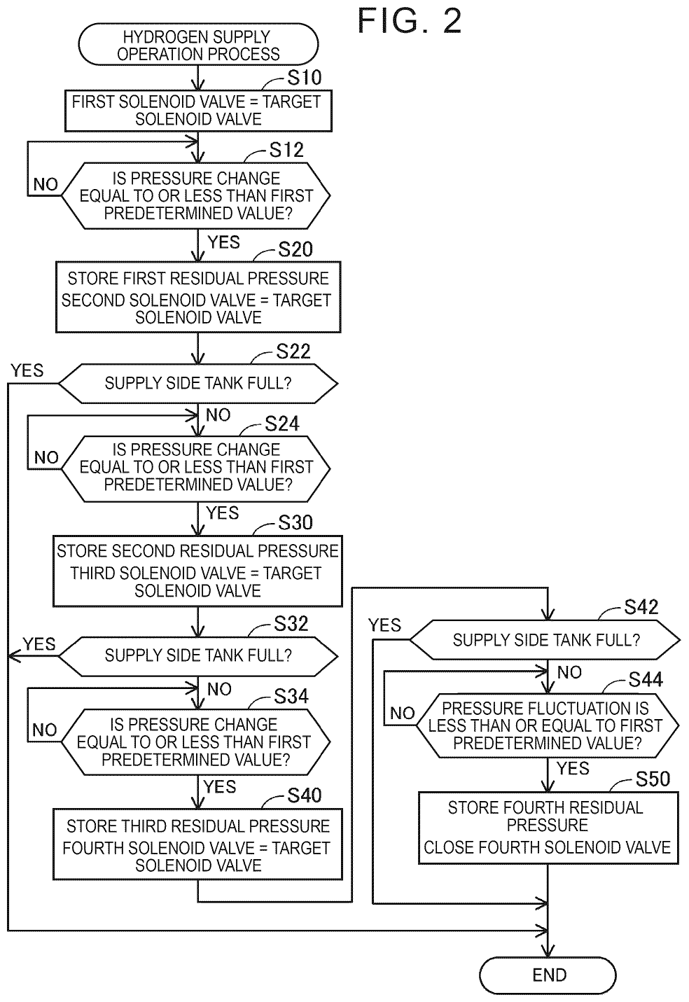

### Hydrogen Supply Operation; FIG. 2

Referring to FIG. 2, a hydrogen supply operation process executed by the control device 28 of the hydrogen storage device 20 will be described. The control device 28 starts the process of FIG. 2 when the second supply pipe 62 is connected between the hydrogen storage device 20 and the supply destination tank 100. In the following, the four hydrogen tank units 26, in the order that lies on the right side from the left side, the first hydrogen tank unit 26, the second hydrogen tank unit 26, the third hydrogen tank unit 26, and the fourth hydrogen tank unit 26. Further, components of the first hydrogen tank unit 26, the second hydrogen tank unit 26, the third hydrogen tank unit 26, and the fourth hydrogen tank unit 26 will be described with reference to “first”, “second”, “third”, and “fourth”.

In S10, the control device 28 sets the first solenoid valve 46 as the target solenoid valve. The target solenoid valve is a solenoid valve to be opened. Thus, only the first solenoid valve 46 is opened, and the second solenoid valve 46 to the fourth solenoid valve 46 are closed. In this case, hydrogen gas is supplied from the first hydrogen tank 40 to the supply destination tank 100.

In S12, the control device 28 monitors that the pressure variation of the first tank pressure of the first hydrogen tank 40 becomes equal to or less than the first predetermined value. Specifically, the control device 28 identifies the pressure detected by the second pressure sensor 24A as the first tank pressure, and monitors that a change in first tank pressure becomes equal to or less than the first predetermined value. The first predetermined value is a threshold value for determining that the hydrogen gas supply amount from the hydrogen tank 40 to the supply destination tank 100 is equal to or less than the first predetermined amount. The first predetermined value is also a threshold value for determining that the first tank pressure and the supply destination tank pressure, which is the pressure of the supply destination tank 100, are substantially the same. If the control device 28 determines YES in S12, it proceeds to S20.

In S20, the control device 28 stores the first tank pressure as the first residual pressure in 28A. The control device 28 sets the second solenoid valve 46 as the target solenoid valve. As a result, only the second solenoid valve 46 is opened, and the first solenoid valve 46, the third solenoid valve 46, and the fourth solenoid valve 46 are closed. In this case. Hydrogen gas is supplied from the second hydrogen tank 40 to the supply destination tank 100.

In S22, the control device 28 determines whether the supply destination tank 100 is full. Specifically, the control device 28 identifies the pressure detected by the second pressure sensor 24A as the second tank pressure. The control device 28 determines that the supply destination tank 100 is full when the second tank pressure does not substantially change immediately after the second solenoid valve 46 is switched to the open state. When the control device 28 determines that the supply destination tank 100 is full (YES in S22), the solenoid valve 46 is closed and the process of FIG. 2 is terminated. On the other hand, when the control device 28 determines that the supply destination tank 100 is not full (NO in S22), it proceeds to S24.

S24 is similar to S12 except that a second tank pressure is utilized. If the control device 28 determines YES in S24, it proceeds to S30.

In S30, the control device 28 stores the second tank pressure as the second residual pressure in the memory 28A. The control device 28 sets the third solenoid valve 46 as the target solenoid valve. As a result, only the third solenoid valve 46 is opened, and the first solenoid valve 46, the second solenoid valve 46, and the fourth solenoid valve 46 are closed. In this case, hydrogen gas is supplied from the third hydrogen tank 40 to the supply destination tank 100.

S32, S34 is the same as S22, S24 except that the pressure detected by the second pressure sensor 24A is used as the third tank pressure instead of the second tank pressure. The control device 28 closes the third solenoid valve 46 and ends the process of FIG. 2 when it is determined that S32 is YES. In addition, when the control device 28 determines NO in S32, it proceeds to S34. Further, when the control device 28 determines that S34 is YES, the processing proceeds to S40.

In S40, the control device 28 stores the third tank pressure as the third residual pressure in the memory 28A. The control device 28 sets the fourth solenoid valve 46 as the target solenoid valve. Thus, only the fourth solenoid valve 46 is opened, and the third solenoid valve 46 is closed from the first solenoid valve 46. In this case, hydrogen gas is supplied from the fourth hydrogen tank 40 to the supply destination tank 100.

S42, S44 is the same as S22, S24 except that the pressure detected by the second pressure sensor 24A is used as the fourth tank pressure instead of the second tank pressure. When the control device 28 determines YES in S42, the fourth solenoid valve 46 is closed and the process of FIG. 2 is ended. In addition, when the control device 28 determines NO in S42, it proceeds to S44. Further, when the control device 28 determines that S44 is YES, the processing proceeds to S50.

In S50, the control device 28 stores the fourth tank pressure as the fourth residual pressure in the memory 28A. The control device 28 also closes the fourth solenoid valve 46. As a result, the first solenoid valve 46 to the fourth solenoid valve 46 are closed, and the supply of the hydrogen gas to the supply destination tank 100 is stopped. When S50 ends, the control device 28 ends the process of FIG. 2.

### Specific Case

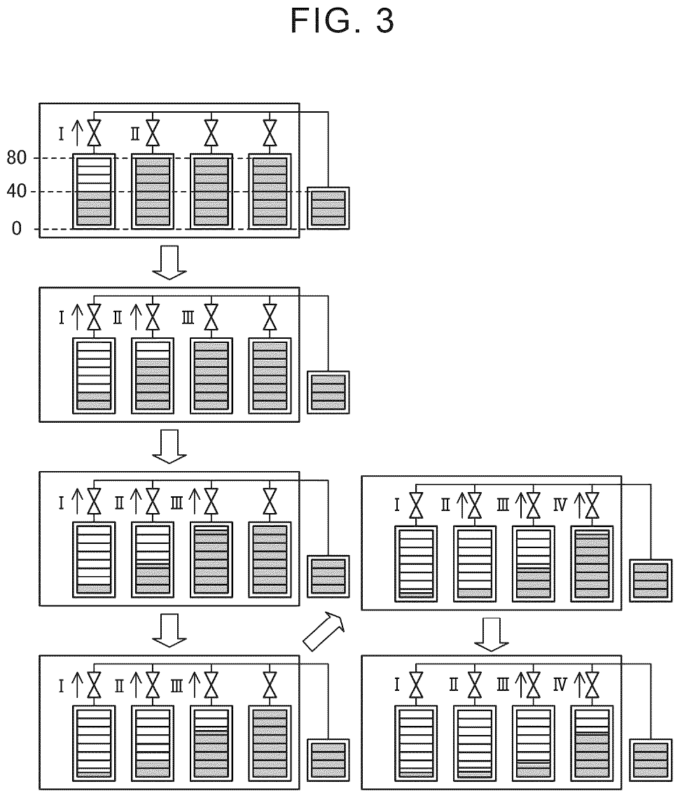

A specific case realized by the supply system 2 of the present embodiment will be described with reference to FIG. 3. In the initial state of the case of FIG. 3, the first hydrogen tank 40 to the fourth hydrogen tank 40 are filled with hydrogen gas. In FIG. 3, a gray portion in each hydrogen tank 40 indicates a portion filled with hydrogen gas, and a white portion indicates a portion not filled with hydrogen gas. FIG. 3 illustrates a case where the tank pressure when the hydrogen gas is filled in the hydrogen tank 40 is 80 Mpa and the supply destination tank pressure when the hydrogen gas is filled in the supply destination tank 100 is 40 Mpa. That is, it is a case where the amount of hydrogen gas that can be filled in the supply destination tank 100 is half of the amount of hydrogen gas that can be filled in the hydrogen tank 40. Roman numerals in FIG. 3 indicate the order in which the solenoid valve 46 is opened.

First, in the top-left view of FIG. 3, when the supply destination tank 100 is connected to the hydrogen storage device 20, the control device 28 opens the first solenoid valve 46 (S10). When the supply destination tank 100 becomes full, the pressure of the first hydrogen tank 40 and the pressure of the supply destination tank 100 become substantially the same. Accordingly, the control device 28 determines that the amount of change in first tank pressure is equal to or less than the first predetermined value (YES in S12), stores the first tank pressure as the first residual pressure in the memory 28A, closes the first solenoid valve 46, and opens the second solenoid valve 46 (S20). At this point, since the supply destination tank 100 is full, hydrogen is not supplied from the second hydrogen tank 40 to the supply destination tank 100. Therefore, the second tank pressure does not fluctuate. In this instance, the control device 28 determines that the supply destination tank 100 is full (YES in S22), and closes the second solenoid valve 46.

Next, in the second view from the upper left of FIG. 3, when the supply destination tank 100 is connected to the hydrogen storage device 20, the control device 28 opens the first solenoid valve 46 (S10). Before the supply destination tank 100 becomes full, the pressure of the first hydrogen tank 40 and the pressure of the supply destination tank 100 become substantially the same. In this case, the control device 28 determines that the amount of change in first tank pressure is equal to or less than the first predetermined value (YES in S12), stores the first tank pressure as the first residual pressure in the memory 28A, closes the first solenoid valve 46, and opens the second solenoid valve 46 (S20). At this time, since the second tank pressure is higher than the supply destination tank pressure, the hydrogen gas is supplied from the second hydrogen tank 40 to the supply destination tank 100. Therefore, the second tank pressure fluctuates. The control device 28 then determines that the supply destination tank 100 is not full (NO in S22). Thereafter, the second tank pressure no longer changes when the supply destination tank 100 becomes full. In this case, the control device 28 determines that the amount of change in second tank pressure is equal to or less than the first predetermined value (YES in S24), stores the second tank pressure as the second residual pressure in the memory 28A, closes the second solenoid valve 46, and opens the third solenoid valve 46 (S30). At this time, since the supply destination tank 100 is full, the hydrogen gas is not supplied from the third hydrogen tank 40 to the supply destination tank 100. Therefore, the third tank pressure does not fluctuate. In this instance, the control device 28 determines that the supply destination tank 100 is full (YES in S32), and closes the third solenoid valve 46.

Thereafter, in the third view from the top left of FIG. 3, the fourth view from the top left of FIG. 3, the top right of FIG. 3, and the second view from the top left of FIG. 3, operation of the first solenoid valve 46, the second solenoid valve 46, the third solenoid valve 46, and the fourth solenoid valve 46 is controlled in accordance with the hydrogen supply operation process of FIG. 2, the supply destination tank 100 becomes full. At the end of the second view from the top left of FIG. 3, the first to third residual pressures are lower than the pressure when the supply destination tank 100 becomes full, and the fourth residual pressure is slightly higher than the pressure when the supply destination tank 100 becomes full. In such a situation, even if the seventh supply destination tank 100 is connected to the hydrogen storage device 20, the supply destination tank 100 cannot be filled. That is, in the present embodiment, it is possible to fill the six supply destination tanks 100 in response to the hydrogen supply operation process of FIG. 2 being executed.

### Effect of This Example

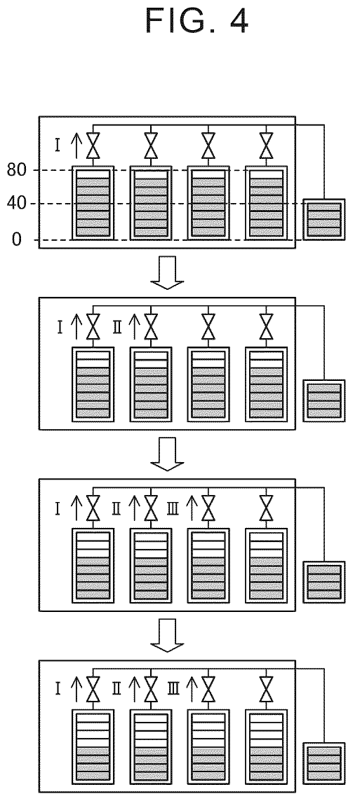

Before describing the effects of the present embodiment, a configuration in which the supply destination tank 100 is filled using the supply system of the comparative example will be described with reference to FIG. 4. In the supply system of the comparative example, the control device of the comparative example does not individually operate the first solenoid valve 46, the second solenoid valve 46, the third solenoid valve 46, and the fourth solenoid valve 46. Specifically, the control device of the comparative example simultaneously sets the first solenoid valve 46, the second solenoid valve 46, the third solenoid valve 46, and the fourth solenoid valve 46 to the open state or the closed state.

First, in the top view of FIG. 4, when the supply destination tank 100 is connected to the hydrogen storage device 20, the control device of the comparative example simultaneously opens the first solenoid valve 46 to the fourth solenoid valve 46. In this case, hydrogen gas is simultaneously supplied from the first hydrogen tank 40 to the fourth hydrogen tank 40 to the supply destination tank 100. Then, when the supply destination tank 100 becomes full, the supply of the hydrogen gas from the first hydrogen tank 40 to the fourth hydrogen tank 40 to the supply destination tank 100 is stopped. According to such a configuration, the hydrogen gas in the first hydrogen tank 40 to the fourth hydrogen tank 40 is uniformly consumed. Therefore, the first to fourth residual pressures become the same.

Then, the second view from the top of FIG. 4, the third view from the top of FIG. 4, and the fourth view from the top of FIG. 4 are as follows. When the first solenoid valve 46 to the fourth solenoid valve 46 are simultaneously opened and the hydrogen gas is simultaneously supplied from the first hydrogen tank 40 to the fourth hydrogen tank 40 to the supply destination tank 100, the supply destination tank 100 becomes full. At the end of the fourth view from the top of FIG. 4, the first to fourth residual pressures are the same as the pressure when the supply destination tank 100 becomes full. Therefore, in the supply system of the comparative example, even if the fifth supply destination tank 100 is connected to the hydrogen storage device 20, the supply destination tank 100 cannot be filled. That is, in the supply system of the comparative example, only four supply destination tanks 100 which are smaller than the supply system 2 of the present embodiment can be filled.

As described above, the hydrogen storage device 20 includes a plurality of hydrogen tanks 40, a plurality of first supply pipes 44 (an example of “supply pipes”), a plurality of solenoid valves 46, and a control device 28. The plurality of first supply pipes 44 correspond to the plurality of hydrogen tanks 40, respectively. The hydrogen tank 40 and a supply destination tank 100 (an example of a “supply destination”) to which the hydrogen gas in the hydrogen tank 40 is supplied are connected to each other by a plurality of first supply pipes 44. The plurality of solenoid valves 46 are provided in each of the plurality of first supply pipes 44. The control device 28 is capable of performing a hydrogen supply operation of supplying hydrogen gas to the supply destination tank 100 by controlling the operations of the plurality of solenoid valves 46. In the hydrogen supply operation, the control device 28 sets the target solenoid valve out of the plurality of solenoid valves 46 to the open state. The control device 28 closes a solenoid valve other than the target solenoid valve (S10, S20, S30 in FIG. 2). The control device 28 changes the solenoid valve 46 set as the target solenoid valve (S20, S30, S40) when the pressure variation becomes equal to or less than the first predetermined value (an example of “a case where the predetermined condition is satisfied”) (YES in YES, S16 by YES, S14 in S12).

In the above configuration, in the hydrogen supply operation, only the target solenoid valve is opened. In this case, the tank pressure of each hydrogen tank may be different. In the hydrogen supply operation, if the tank pressure of any of the hydrogen tanks 40 among the plurality of hydrogen tanks 40 is higher than the pressure of the supply destination tank 100, the hydrogen gas can be supplied to the supply destination tank 100. Therefore, the hydrogen gas stored in the plurality of hydrogen tanks 40 can be effectively utilized.

Further, according to the above configuration, the solenoid valve 46 set as the target solenoid valve can be changed at a timing at which the supply of the hydrogen gas from the hydrogen tank 40 corresponding to the target solenoid valve to the supply destination is reduced.

Further, the control device 28 sets the target solenoid valve in order from the solenoid valve 46 corresponding to the hydrogen tank 40 having a small tank pressure at the start of the hydrogen supply operation.

In the hydrogen supply operation, the pressure of the supply destination tank 100 increases in response to the supply of the hydrogen gas to the supply destination tank 100. Thus, the pressure of the supply destination tank 100 may be higher than the lowest tank pressure while the hydrogen supply operation is being performed. According to the above configuration, when the solenoid valve 46 corresponding to the hydrogen tank 40 having the lowest tank pressure is set to the open state, it is possible to increase the possibility that the hydrogen gas is supplied from the hydrogen tank to the supply destination tank 100. Therefore, the hydrogen gas stored in the plurality of hydrogen tanks 40 can be more effectively utilized.

### Second Embodiment

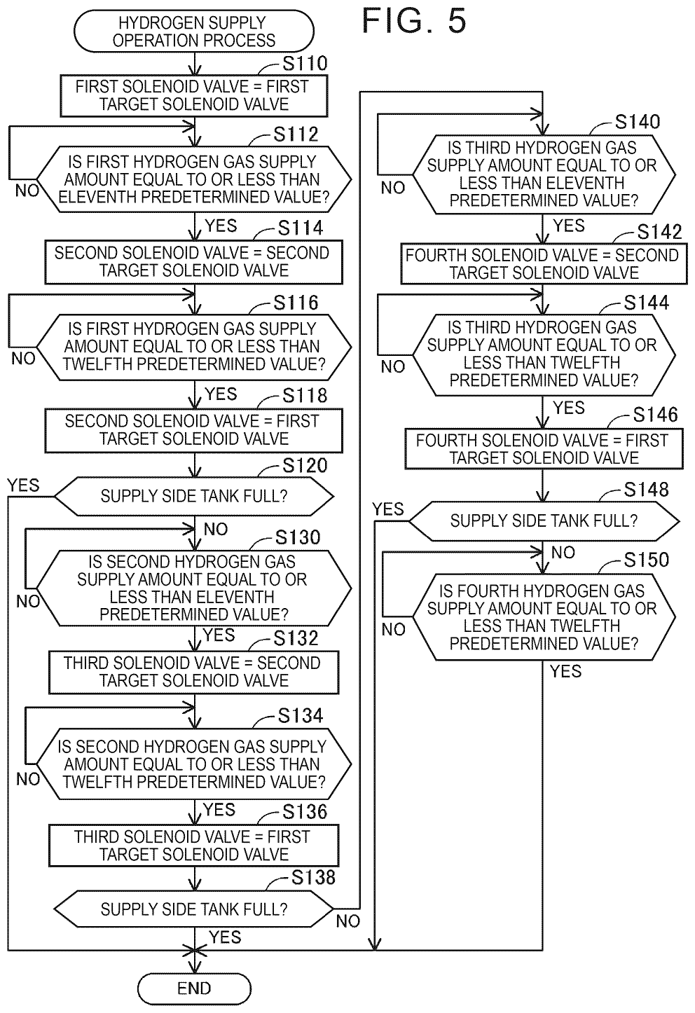

The supply system 2 of the second embodiment will be described. The supply system 2 of the second embodiment is the same as the supply system 2 of the first embodiment except that the hydrogen supply operation process of FIG. 5 is executed instead of the hydrogen supply operation process of FIG. 2.

### Hydrogen Supply Operation; FIG. 5

With reference to FIG. 5, a hydrogen supply operation process executed by the control device 28 of the hydrogen storage device 20 will be described. The control device 28 starts the process of FIG. 5 when the second supply pipe 62 is connected between the hydrogen storage device 20 and the supply destination tank 100.

In S110, the control device 28 sets the first solenoid valve 46 as the first target solenoid valve. The first target solenoid valve is a target solenoid valve to be set to the open state. Thus, only the first solenoid valve 46 is opened, and the second solenoid valve 46 to the fourth solenoid valve 46 are closed. In this case, hydrogen gas is supplied from the first hydrogen tank 40 to the supply destination tank 100.

In S112, the control device 28 monitors that the first hydrogen gas supply amount from the first hydrogen tank 40 to the supply destination tank 100 is equal to or less than the eleventh predetermined value. In an exemplary embodiment, the control device 28 specifies the first hydrogen gas supply amount based on the amount of change in first tank pressure detected by the second pressure sensor 24A. The control device 28, when the first hydrogen gas supply amount is equal to or less than the eleventh predetermined value, it is determined that YES at S112, and proceeds to S114.

In S114, the control device 28 sets the second solenoid valve 46 as the second target solenoid valve. The second target solenoid valve is the solenoid valve to be opened and is then set as the first target solenoid valve. Thus, the first solenoid valve 46 and the second solenoid valve are opened, and the third solenoid valve 46 and the fourth solenoid valve 46 are closed. In this case, hydrogen gas is supplied from the first hydrogen tank 40 and the second hydrogen tank 40 to the supply destination tank 100.

In S116, the control device 28 monitors that the first hydrogen gas supply amount is equal to or less than the twelfth predetermined value. The twelfth predetermined value is a value smaller than the eleventh predetermined value. The twelfth predetermined value is a threshold value for determining that the supply of the hydrogen gas from the hydrogen tank 40 corresponding to the first target solenoid valve to the supply destination tank 100 has stopped. In an exemplary embodiment, the control device 28 specifies the first hydrogen gas supply amount based on the amount of change in tank temperature detected by the first temperature sensor 40A. The control device 28 determines YES in S116 when the hydrogen gas supply amount is equal to or less than the twelfth predetermined value, and proceeds to S118.

In S118, the control device 28 changes the second solenoid valve 46 to the first target solenoid valve. As a result, only the second solenoid valve 46 is opened, and the first solenoid valve 46, the third solenoid valve 46, and the fourth solenoid valve 46 are closed. In this case, hydrogen gas is supplied from the second hydrogen tank 40 to the supply destination tank 100.

S120 is similar to S22 of FIG. 2. When the control device 28 determines YES in S120, the control device 28 closes the second solenoid valve 46 and ends the process of FIG. 5. When the control device 28 determines NO in S120, the control device 28 proceeds to S130.

S130 is the same as in S112 except that the second hydrogen gas supply amount from the second hydrogen tank 40 to the supply destination tank 100 is used. If the control device 28 determines YES in S130, it proceeds to S132.

In S132, the control device 28 sets the third solenoid valve 46 as the second target solenoid valve. Accordingly, the second solenoid valve 46 and the third solenoid valve are opened, and the first solenoid valve 46 and the fourth solenoid valve 46 are closed. In this case, hydrogen gas is supplied from the second hydrogen tank 40 and the third hydrogen tank 40 to the supply destination tank 100.

S134 is similar to S116 except that the second hydrogen gas supply amount is utilized. If the control device 28 determines YES in S134, it proceeds to S136.

In S136, the control device 28 changes the third solenoid valve 46 to the first target solenoid valve. As a result, only the third solenoid valve 46 is opened, and the first solenoid valve 46, the second solenoid valve 46, and the fourth solenoid valve 46 are closed. In this case, hydrogen gas is supplied from the third hydrogen tank 40 to the supply destination tank 100.

S138 is similar to S22 of FIG. 2. When the control device 28 determines YES in S138, the control device 28 closes the third solenoid valve 46 and ends the process of FIG. 5. In addition, when the control device 28 determines NO in S138, it proceeds to S140.

S140 is the same as in S112 except that the third hydrogen gas supply amount from the third hydrogen tank 40 to the supply destination tank 100 is used. If the control device 28 determines YES in S140, it proceeds to S142.

In S142, the control device 28 sets the fourth solenoid valve 46 as the second target solenoid valve. As a result, the third solenoid valve 46 and the fourth solenoid valve 46 are opened, and the first solenoid valve 46 and the second solenoid valve 46 are closed. In this case, hydrogen gas is supplied from the third hydrogen tank 40 and the fourth hydrogen tank 40 to the supply destination tank 100.

S144 is similar to S116 except that the third hydrogen gas supply amount is utilized. When the control device 28 determines YES in S144, the control device 28 proceeds to S146.

In S146, the control device 28 changes the fourth solenoid valve 46 to the first target solenoid valve. Thus, only the fourth solenoid valve 46 is opened, and the third solenoid valve 46 is closed from the first solenoid valve 46. In this case, hydrogen gas is supplied from the fourth hydrogen tank 40 to the supply destination tank 100.

S148 is similar to S22 of FIG. 2. When the control device 28 determines YES in S148, the fourth solenoid valve 46 is closed and the process of FIG. 5 is terminated. In addition, when the control device 28 determines NO in S148, it proceeds to S150.

S150 is the same as in S116 except that the fourth hydrogen gas supply amount from the fourth hydrogen tank 40 to the supply destination tank 100 is used. When the control device 28 determines YES in S150, the fourth solenoid valve 46 is closed and the process of FIG. 5 is terminated.

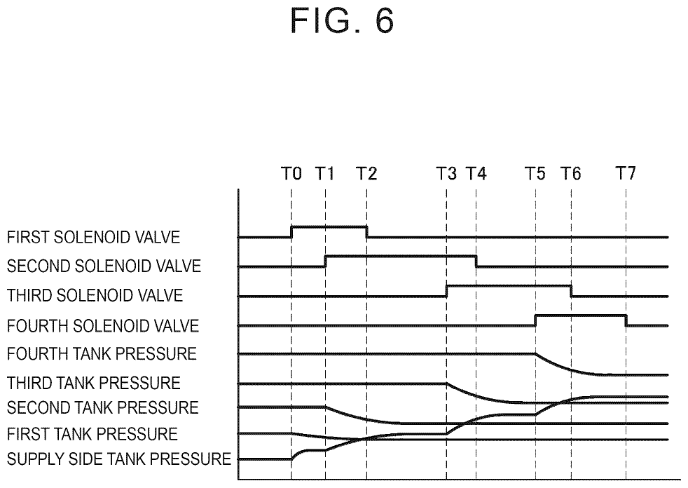

### Specific Case; FIG. 6

A specific case realized by the supply system 2 of the present embodiment will be described with reference to FIG. 6. In the initial state of the case of FIG. 6, the tank pressure is larger in the order of the first tank pressure, the second tank pressure, the third tank pressure, and the fourth tank pressure.

At time T0, the supply destination tank 100 is connected to the hydrogen storage device 20. Accordingly, the control device 28 sets the first solenoid valve 46 as the first target solenoid valve to open the first solenoid valve 46 and close from the second solenoid valve 46 to the fourth solenoid valve 46 (S110 in FIG. 5). In this case, hydrogen gas is supplied from the first hydrogen tank 40 to the supply destination tank 100. In time T1, the control device 28 determines that the first hydrogen gas supply amount is equal to or less than the eleventh predetermined value (YES in S112), sets the second solenoid valve 46 as the second target solenoid valve, and open the second solenoid valve 46 (S114). In this case, hydrogen gas is supplied from the first hydrogen tank 40 and the second hydrogen tank 40 to the supply destination tank 100. At the time T2, the control device 28 determines that the first hydrogen gas supply amount is equal to or less than the twelfth predetermined value (YES in S116), and changes the second solenoid valve 46 to the first target solenoid valve (S118). Accordingly, the second solenoid valve 46 is opened, and the first solenoid valve 46, the third solenoid valve 46, and the fourth solenoid valve 46 are closed. In this case, hydrogen gas is supplied from the second hydrogen tank 40 to the supply destination tank 100. In addition, the control device 28 determines that the supply destination tank 100 is not full (NO in S120).

Thereafter, the operation of the second solenoid valve 46 to the fourth solenoid valve 46 is controlled in accordance with S148 from S130 of FIG. 5. Specifically, in the time T3, the third solenoid valve 46 is set as the second target solenoid valve (S132). At the time T4, the third solenoid valve 46 is changed to the first target solenoid valve (S136). At time T5, the fourth solenoid valve 46 is set as the second target solenoid valve (S134). At the time T6, the fourth solenoid valve 46 is changed to the first target solenoid valve (S146). Next, at time T7, the control device 28 determines that the fourth hydrogen gas supply amount is equal to or smaller than the twelfth predetermined value (YES in S150), and closes the fourth solenoid valve 46. In this manner, the supply of the hydrogen gas from the plurality of hydrogen tanks 40 to the supply destination tank 100 is performed.

### Effect of This Example

As described above, in the hydrogen supply operation, the control device 28 opens the first target solenoid valve of the plurality of solenoid valves 46 and closes the solenoid valves other than the first target solenoid valve (S110, S118, S136 in FIG. 5). There is a case where, with the first target solenoid valve opened and the solenoid valve other than the first target solenoid valve closed, the hydrogen gas supply amount from the hydrogen tank 40 corresponding to the first target solenoid valve becomes equal to or less than the eleventh predetermined value (example of the first predetermined amount) (YES in YES, S140 with YES, S130 in S112). Here, the control device 28 opens the second target solenoid valve out of the solenoid valves 46 (S114, S132, S142). After the second target solenoid valve is set to the open state, the hydrogen gas supply amount from the hydrogen tank, the 12 predetermined value (an example of the second predetermined amount) or less (YES in YES, S144 in YES, S134 in S116) in some cases. In this case, the control device 28 closes the first target solenoid valve.

In the above configuration, in the hydrogen supply operation, the first target solenoid valve or the first target solenoid valve and the second target solenoid valve are opened. In this case, the tank pressure of each hydrogen tank 40 may be different. Therefore, in the hydrogen supply operation, if the tank pressure of any of the hydrogen tanks 40 of the plurality of hydrogen tanks 40 is higher than the pressure of the supply destination, it is possible to supply the hydrogen gas to the supply destination. Therefore, the hydrogen gas stored in the plurality of hydrogen tanks 40 can be effectively utilized.

In addition, in the above-described configuration, the second target solenoid valve is opened in a state in which the first target solenoid valve is opened. Therefore, the time required to supply the hydrogen gas to the supply destination tank 100 can be shortened as compared with a configuration in which the second target solenoid valve is opened after the first target solenoid valve is switched from the open state to the closed state.

At the start of the hydrogen supply operation, the tank pressure of the hydrogen tank 40 corresponding to the second target solenoid valve is greater than the tank pressure of the hydrogen tank 40 corresponding to the first target solenoid valve.

According to the above configuration, it is possible to increase the possibility that the hydrogen gas is supplied from the hydrogen tank 40 corresponding to the second target solenoid valve to the supply destination tank 100 after the state change. After the state changes means after the state changes from the state in which only the first target solenoid valve is open to the state in which the first target solenoid valve and the second target solenoid valve are open.

While specific examples of the technology disclosed in the present specification have been described in detail above, these examples are merely illustrative and do not limit the scope of the claims. The technique described in the claims includes various modifications and variations of the specific examples exemplified above. Variations of the above embodiments are listed below.

### First Modification

In S12, S24, S34, S44 of FIG. 2 of the first embodiment, when the temperature variation of the tank temperature is equal to or less than the second predetermined value, the control device 28 may determine that the temperature variation is YES in the respective processes. The second predetermined value is a threshold value for determining that the hydrogen gas supply amount from the hydrogen tank 40 to the supply destination tank 100 is equal to or less than the first predetermined amount.

### Second Modification

In S12, S24, S34, S44 of FIG. 2 of the first embodiment, the control device 28 may determine that the process is YES when a predetermined period of time has elapsed. In a predetermined time, a time required for stopping the supply of the hydrogen gas from the hydrogen tank 40 to the supply destination tank 100 is set.

### Third Modification

In the first embodiment and the second embodiment, the control device 28 is set as the first target solenoid valve in the order of the first solenoid valve 46, the second solenoid valve 46, the third solenoid valve 46, and the fourth solenoid valve 46. The control device 28 stores the number of operations of each of the solenoid valves 46, and may be set as the first target solenoid valve in order from the solenoid valve 46 having a smaller number of operations.

### Fourth Modification

In the first embodiment and the second embodiment, the order set as the first target solenoid valve is determined in advance. The order set as the first target solenoid valve is not limited to the order of the first solenoid valve 46, the second solenoid valve 46, the third solenoid valve 46, and the fourth solenoid valve 46 as long as the tank pressure is in a low order. In the present modification, when the hydrogen supply operation process of FIG. 2 is started, the control device 28 specifies the fourth residual pressure from the first residual pressure in the memory 28A, and determines the order in which the solenoid valves are set as the first target solenoid valve using the first to fourth residual pressures.

### Fifth Modification

In S112, S130, S140 of FIG. 5 of the second embodiment, the control device 28 may determine the hydrogen gas supply amount using the temperature variation of the tank temperature.

The technical elements described in this specification or in the drawings may be used alone or in various combinations, and are not limited to the combinations described in the claims at the time of filing. Further, the technology illustrated in the present specification or the drawings can achieve a plurality of objects at the same time, and has technical usefulness by achieving one of the objects.

What is claimed is:

1. A hydrogen storage device, comprising:
a plurality of hydrogen tanks;
a plurality of supply pipes corresponding to the hydrogen tanks and each connecting a corresponding one of the hydrogen tanks and a supply destination to which hydrogen gas in the hydrogen tank is to be supplied;
a plurality of solenoid valves installed in the supply pipes; and
a control device configured to perform a hydrogen supply operation in which the control device controls operation of the solenoid valves to supply the hydrogen gas to the supply destination, wherein the control device is configured to, in the hydrogen supply operation,
set part of the solenoid valves as a target solenoid valve to open the target solenoid valve and close the solenoid valves other than the target solenoid valve, and
when a predetermined condition is satisfied, change the solenoid valve set as the target solenoid valve.

2. The hydrogen storage device according to claim 1, wherein the predetermined condition is satisfied when an amount of change in a tank pressure of the hydrogen tank corresponding to the target solenoid valve becomes equal to or less than a predetermined value.

3. The hydrogen storage device according to claim 1, wherein the control device is configured to set the solenoid valve as the target solenoid valve in an ascending order from the solenoid valve corresponding to the hydrogen tank that has a lowest tank pressure at start of the hydrogen supply operation.

4. A hydrogen storage device, comprising:
a plurality of hydrogen tanks;
a plurality of supply pipes corresponding to the hydrogen tanks;
a plurality of solenoid valves installed in the supply pipes; and
a control device configured to perform a hydrogen supply operation in which the control device controls operation of the solenoid valves to supply hydrogen gas to a supply destination, wherein the control device is configured to, in the hydrogen supply operation,
open a first target solenoid valve out of the solenoid valves and close the solenoid valves other than the first target solenoid valve,
when, with the first target solenoid valve opened and the solenoid valves other than the first target solenoid valve closed, a hydrogen gas supply amount from a first hydrogen tank corresponding to the first target solenoid valve becomes equal to or less than a first predetermined amount, open a second target solenoid valve out of the solenoid valves, and
when, after the second target solenoid valve is opened, the hydrogen gas supply amount from the first hydrogen tank becomes equal to or less than a second predetermined amount smaller than the first predetermined amount, close the first target solenoid valve.

5. The hydrogen storage device according to claim 4, wherein, at start of the hydrogen supply operation, a tank pressure of the hydrogen tank corresponding to the second target solenoid valve is higher than a tank pressure of the hydrogen tank corresponding to the first target solenoid valve.
